(19) United States
(12) Patent Application Publication
(10) Pub. No.: US 2013/0093222 A1
(43) Pub. Date: Apr. 18, 2013

(54) QUICK RELEASE MOTORCYCLE BACKREST

(71) Applicant: Jeff Young, Newport, KY (US)

(72) Inventor: Jeff Young, Newport, KY (US)

(21) Appl. No.: 13/652,774

(22) Filed: Oct. 16, 2012

Related U.S. Application Data
(60) Provisional application No. 61/613,004, filed on Mar. 20, 2012.
(60) Provisional application No. 61/548,478, filed on Oct. 18, 2011.

(51) Int. Cl. B62J 1/28

(52) U.S. Cl. 297/188.04; 297/215.12

(57) ABSTRACT

A motorcycle backrest includes a base fender bracket, and a removable backrest portion. The base fender bracket is adapted to be rigidly secured to a motorcycle at a position residing over the rear fender. The base fender bracket includes first and second upstanding support plates, each including a hole. The removable backrest portion includes a cushion and first and second rearward extending plates each including a hole. A pin is configured to extend through the holes in the upstanding plates and through the holes in the rearward extending plates when aligned to thereby removably couple the removable backrest portion to the base fender bracket.

### CROSS-REFERENCE TO RELATED APPLICATION

This application claims the priority of U.S. Provisional Patent Application Ser. Nos. 61/548,478, filed Oct. 18, 2011 (pending) and 61/613,004, filed Mar. 20, 2012 (pending) the disclosures of which are incorporated by reference herein.

### TECHNICAL FIELD

The present invention generally relates to motorcycle backrests and, more specifically, to backrests that are removable from the motorcycle.

### BACKGROUND

Many different types of motorcycle backrest designs and configurations are known. Some backrests are mounted permanently to the motorcycle, such a by welding. Other backrests are removable and may even include relatively quick releases. In spite of this, it would be desirable to provide further improvements to motorcycle backrests that allow for quick release of the backrest, while retaining a pleasing aesthetic appearance with the backrest removed, and ensuring that the backrest is securely fastened to the motorcycle when attached.

### SUMMARY

Generally, the invention is directed to a motorcycle backrest comprising a base fender bracket adapted to be rigidly secured to a motorcycle at a position residing over the rear fender. The base fender bracket includes first and second upstanding support plates, each including a hole. A removable backrest portion includes a cushion and first and second rearward extending plates each including a hole. A pin is configured to extend through the holes in the upstanding plates and through the holes in the rearward extending plates when aligned to thereby removably couple the removable backrest portion to the base fender bracket. The motorcycle backrest can further comprise an adjustable connection between the removable backrest portion and the base fender bracket allowing an angle between the cushion and the base fender bracket to be adjusted. The upstanding support plates can each include an additional hole, and the rearward extending plates can each include a plurality of position adjustment holes. Another pin is configured to extend through the additional holes in the upstanding support plates and through selected ones of the position adjustment holes in the rearward extending plates to thereby set an angular position of the cushion. In other embodiments, different types of adjustable connections may be used. For example, in one other embodiment, a cam-type adjustment mechanism may be used. More specifically, an adjustment mechanism can have notches in the rearward extending plates defining angle adjustment positions, and mating adjustment pieces or elements fixed on the upstanding support plates. As another optional feature, a backrest cushion may be provided with a vibrating device. The motorcycle backrest can further comprise a luggage rack coupled to the removable backrest portion.

### BRIEF DESCRIPTION OF THE DRAWINGS

FIG. 1 is a perspective front view of the backrest.

FIG. 2 is a perspective rear view of the backrest.

FIGS. 3-7 are respective side views of the backrest showing different positions of adjustability.

FIG. 8 is a perspective view of the fender bracket portion of the backrest.

FIG. 9 is a side view of the backrest illustrating an optional luggage rack.

FIG. 10 is a side view similar to FIG. 9, but showing the luggage rack secured to the backrest at a different orientation relative to the base fender bracket.

FIG. 11 is a perspective front view of another embodiment of a backrest.

FIG. 12 is a perspective rear view of the backrest shown in FIG. 11.

FIGS. 13-17 are respective, side schematic views of the backrest of FIG. 11 showing different positions of adjustability.

FIG. 18 is a rear view of the backrest including an optional vibrating element.

FIG. 19 shows, respectively, a partial perspective view at an upper portion and a rear view of the embodiment illustrated in FIG. 11 at a lower portion of the Figure.

### DETAILED DESCRIPTION

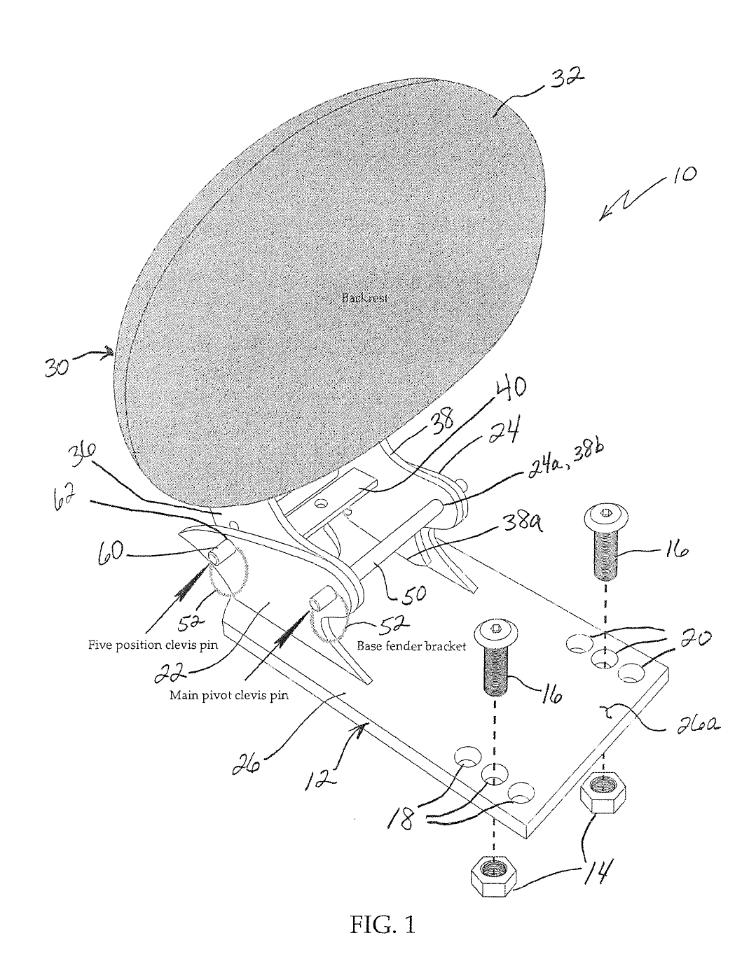

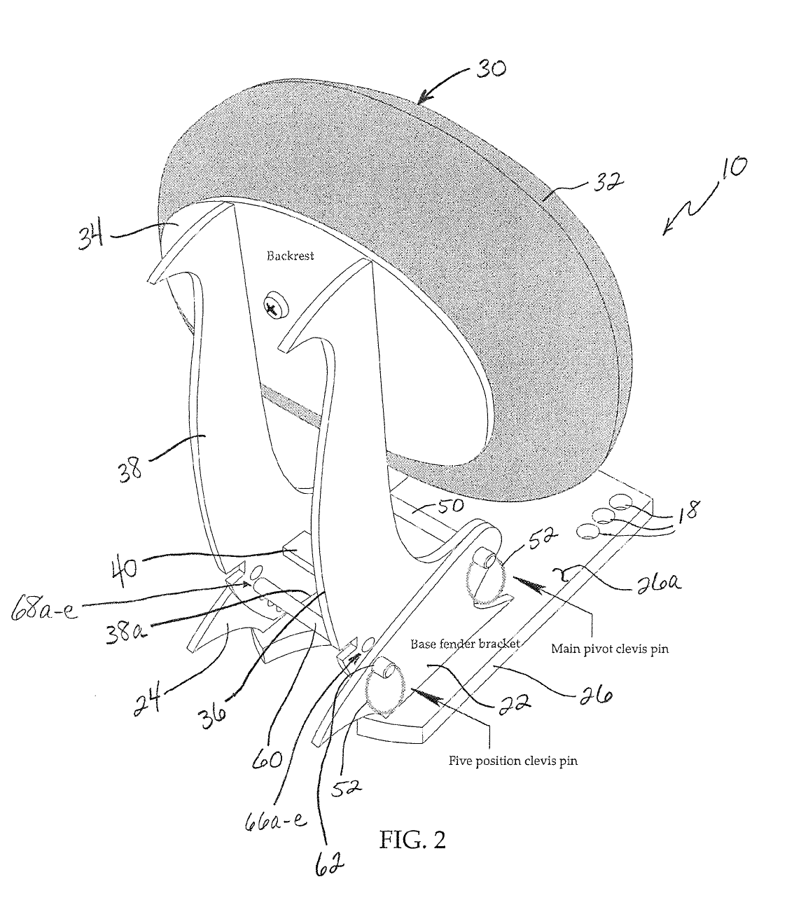

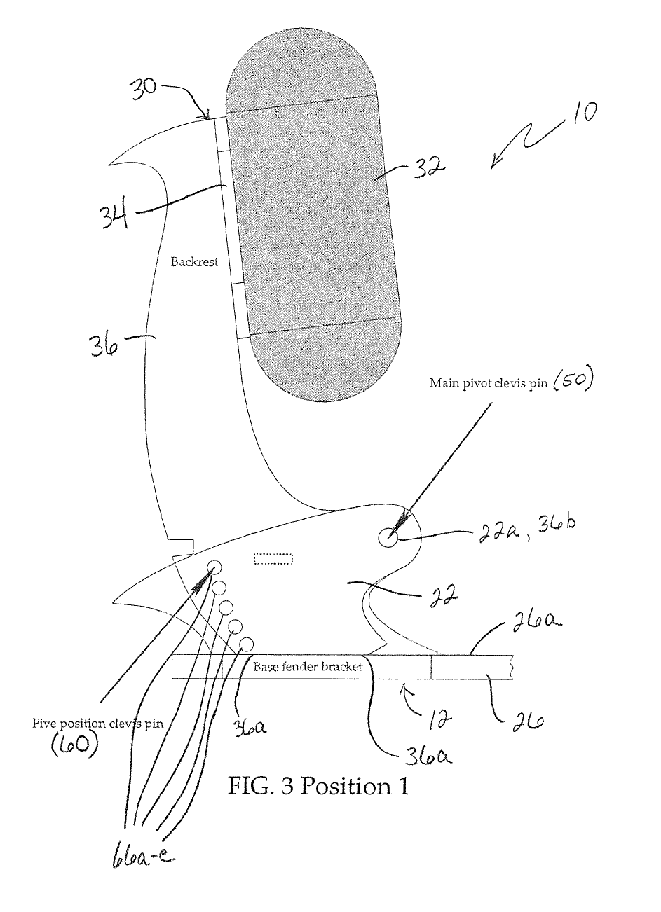

Referring to FIGS. 1-3, the backrest 10 of a first illustrative embodiment includes a base fender bracket 12 that is rigidly connected to the fender (not shown) of a motorcycle, for example, through the use of a pair of nuts 14 and bolts 16 secured through selected holes 18, 20 in the base fender bracket 12. Holes 18, 20 are aligned with holes (not shown) in the motorcycle fender, which may be under the passenger seat. It will be appreciated that other manners of rigidly mounting the base fender bracket 12 to the motorcycle may be used and/or may be necessary in various applications. Respective first and second upstanding backrest mounting plates 22, 24 are provided and are rigidly affixed to a fender attachment plate 26 the base fender bracket 12, such as by welding. A removable backrest portion 30 is further provided and includes a cushion 32 carried by a cushion support plate 34 (FIGS. 2 and 3). The cushion support plate 34 is rigidly affixed to first and second vertical plates 36, 38, such as by welding. The first and second vertical plates 36, 38 are coupled to one another for further support and stability by a horizontal plate member 40 (FIGS. 1 and 2).

In order to securely fix the removable backrest portion 30 to the base fender bracket 12, the removable backrest portion 30 is placed in the position as shown in FIGS. 1-3 with a lower surface 36a, 38a of each vertical plate 36, 38 resting squarely on the upper planar surface 26a of the fender attachment plate 26. Respective holes 36b, 38b in the vertical plates 36, 38 are aligned with holes 22a, 24a of the mounting plates 22, 24 and a main pivot clevis pin 50 is inserted through the aligned holes as shown. The main pivot clevis pin 50 is held in position by appropriate stop elements, such as rings 52 or other elements such as detent mechanisms (not shown).

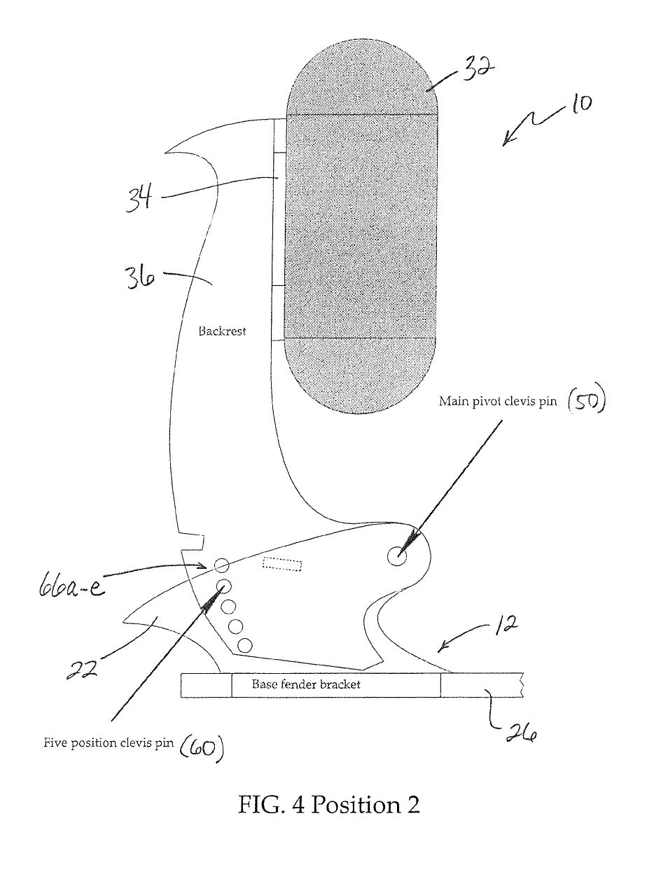

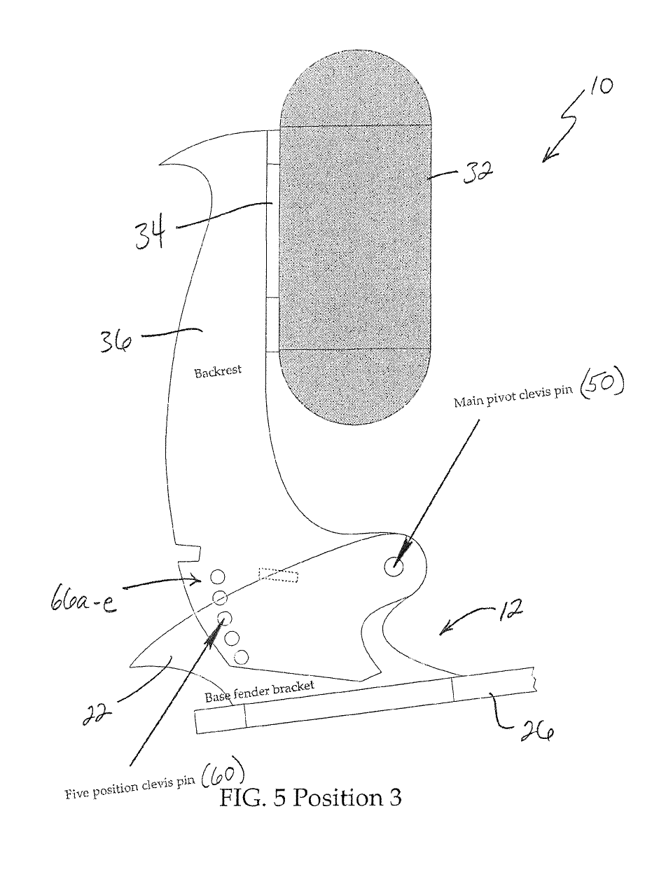

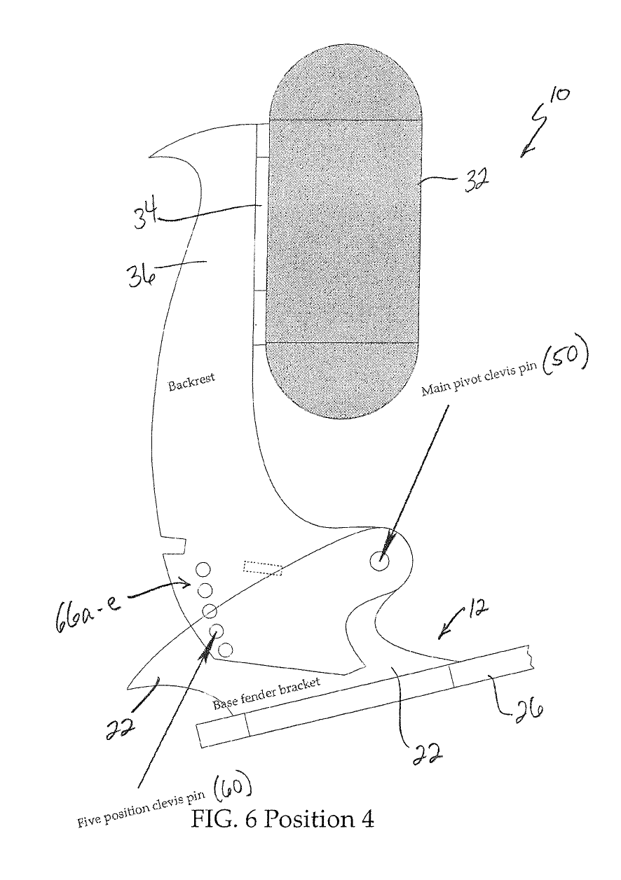

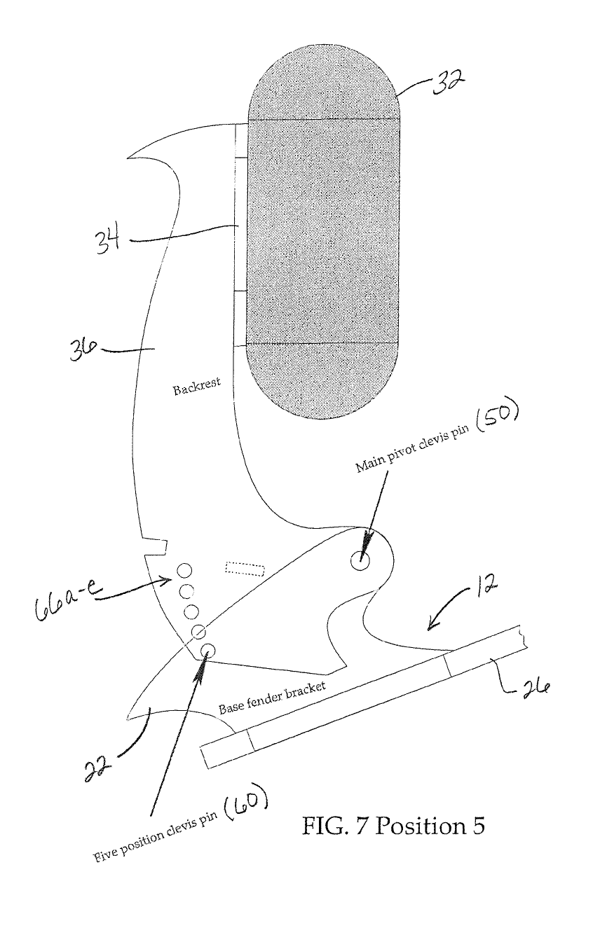

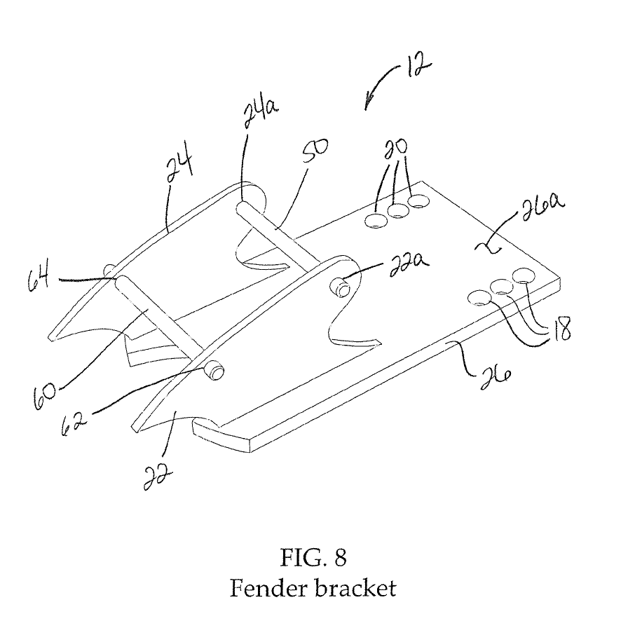

In one embodiment, an adjustability feature is provided for the backrest 10. In this regard, a multi-position clevis pin 60 is provided and may be inserted through aligned holes 62, 64 in the mounting plates 22, 24 and selected holes 66a-e, 68a-e the vertical plates 36, 38. In this example, the user has the option of choosing five different positions to change the angle of the removable backrest portion 30 relative to the base fender bracket 12. This is accomplished by pivoting the backrest portion about clevis pin 50 until the desired holes 66a-e and 68a-e are aligned with holes 62, 64 (FIG. 8). Each position option is shown in respective FIGS. 3, 4, 5, 6 and 7. Due to the interaction of the bottom surfaces 36a, 38a of the vertical plates 36, 38 and the upper planar surface 26a, as well as the location of the main pivot clevis pin 50 and multi-position clevis pin 60, the backrest portion 30 will be securely fastened to the base fender bracket 12 and will not pivot in either direction around the clevis pin 50.

This will allow the backrest 10 to be mounted on several different rear fender styles and configurations while maintaining the backrest portion 30 in a desired angular orientation relative to the passenger seat. Removing each clevis pin 50, 60 will release the removable backrest portion 30 from the base fender bracket 12, leaving the base fender bracket 12 rigidly attached to the fender.

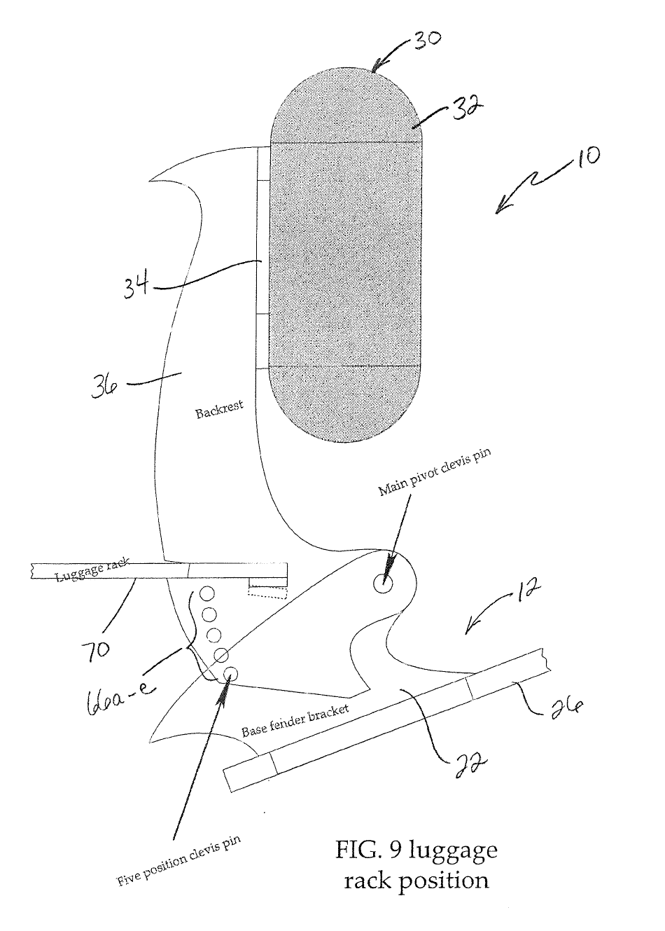

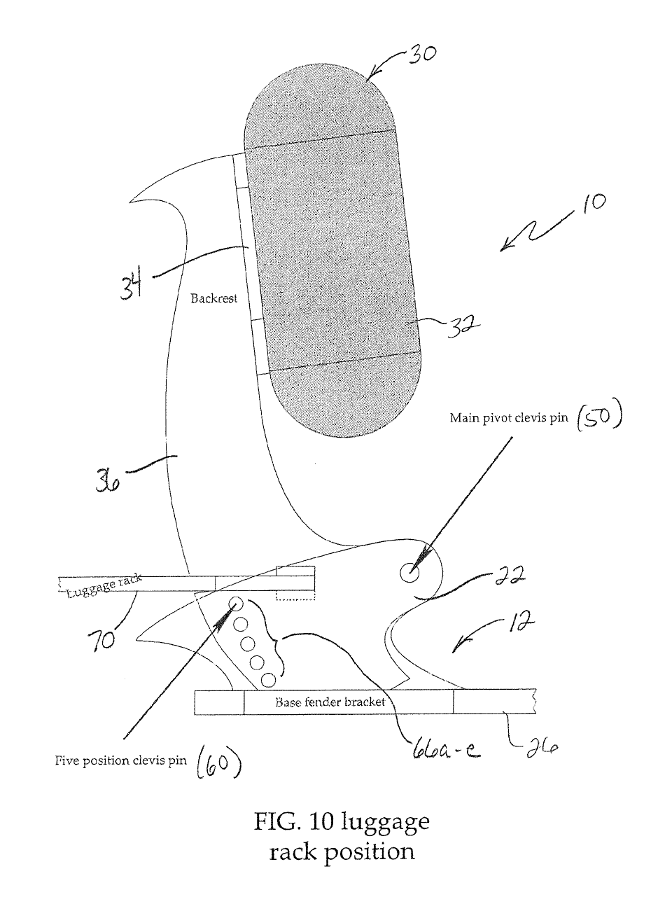

FIGS. 9 and 10 illustrate two additional embodiments including a luggage rack 70 secured to the vertical plates 36, 38 and extending rearwardly from the removable backrest portion 30. The luggage rack 70 preferably has a 90° orientation relative to the backrest cushion 30 (approximately), however, it will be appreciated that the connection between the luggage rack 70 and the vertical plates 36, 38 may also be adjustable to change the angular orientation of the luggage rack 70 relative to the backrest cushion 32.

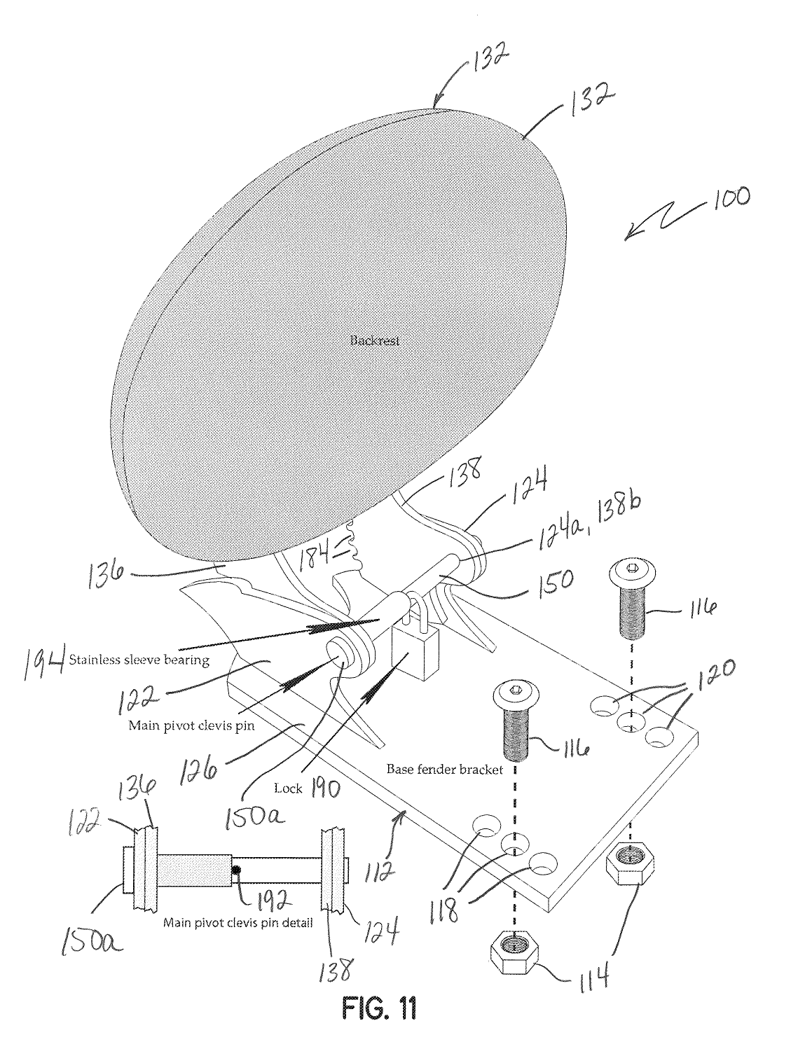

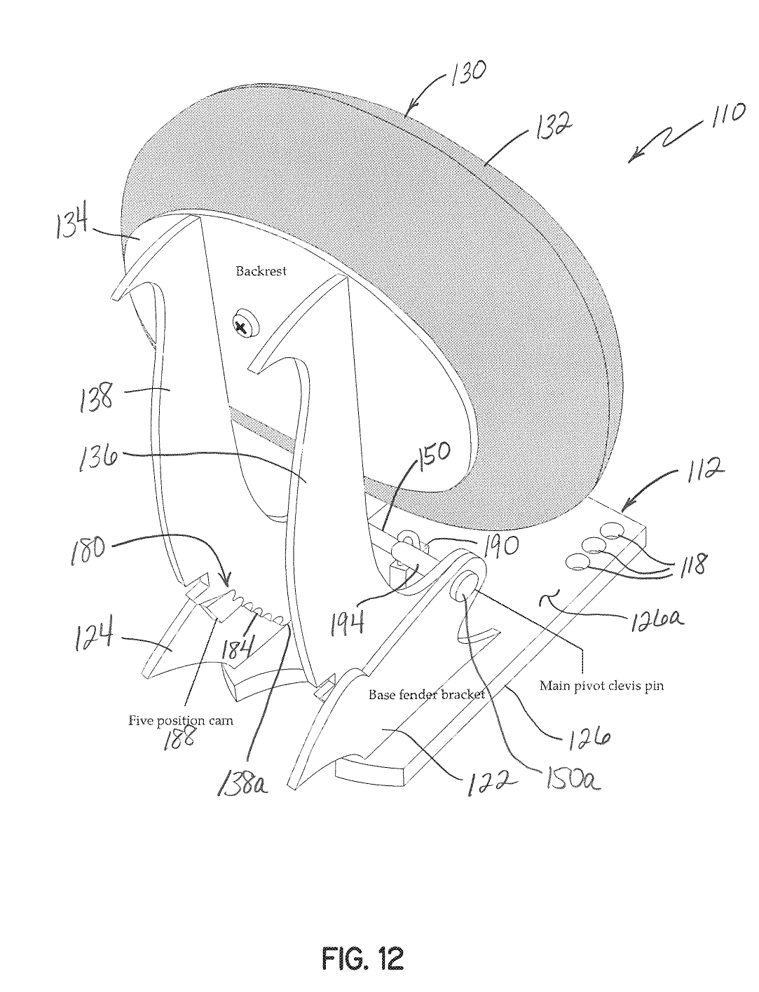

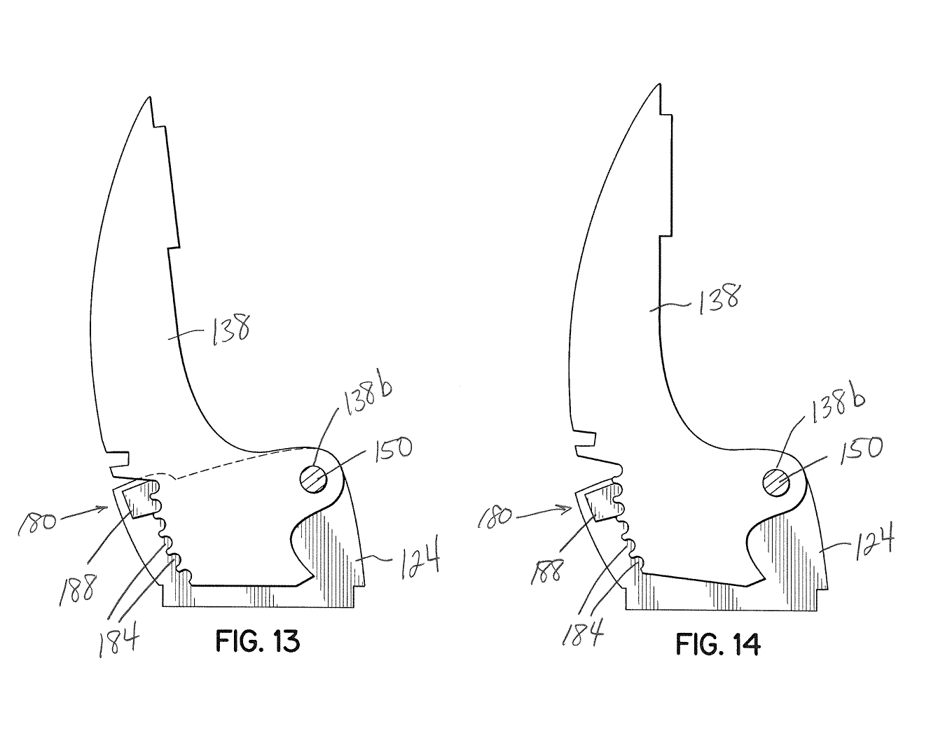

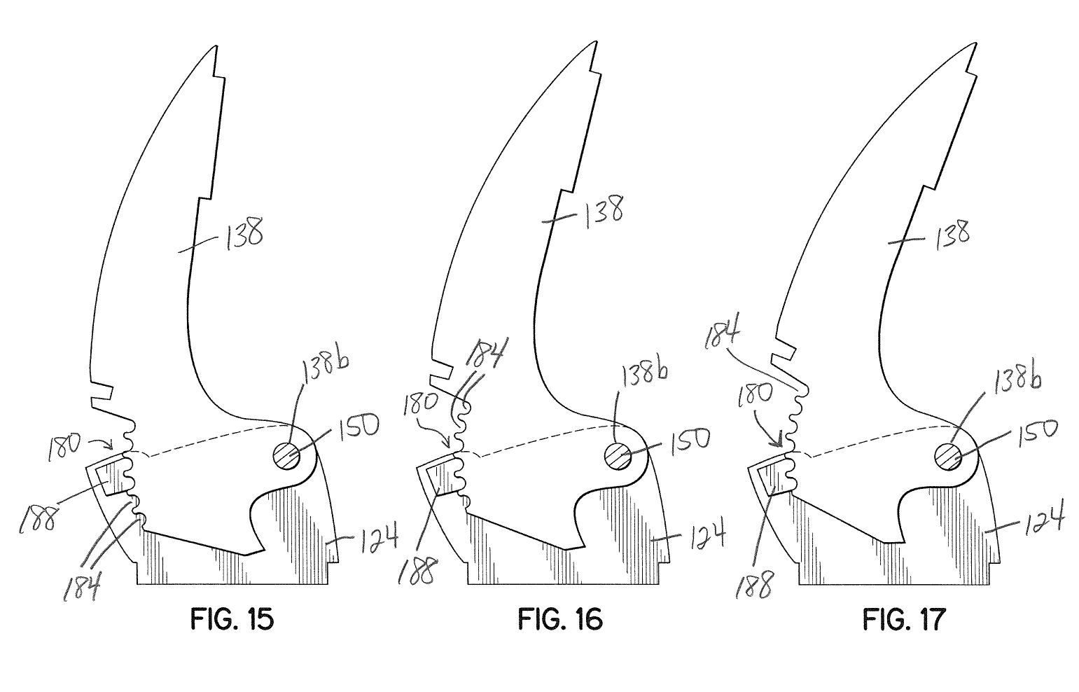

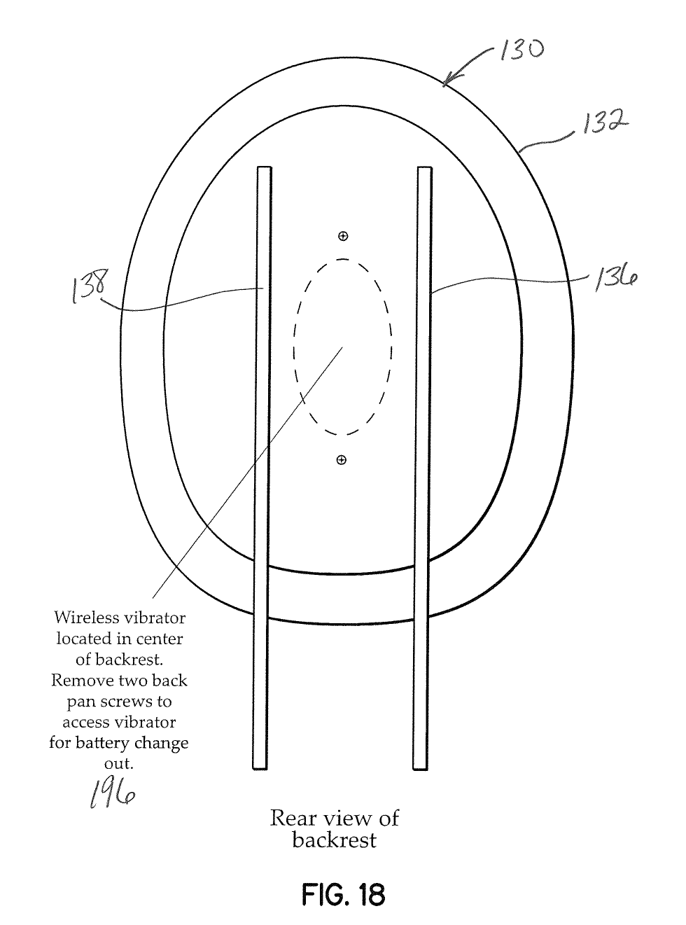

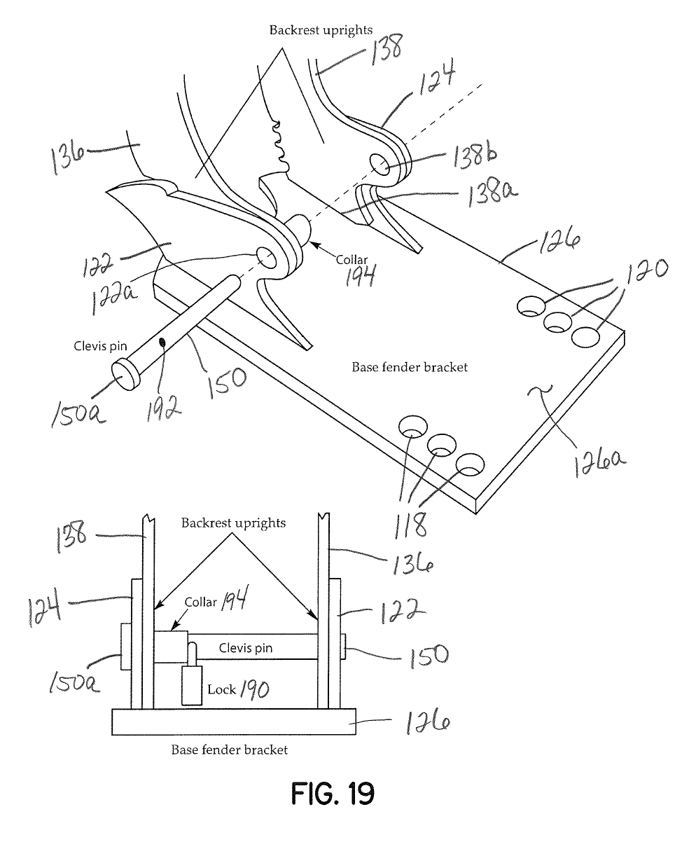

FIGS. 11-19 illustrate another embodiment of a backrest 110. In these drawing figures, the same reference numerals in “100” series format are used to denote the same structure illustrated and discussed in connection with the first embodiment (FIGS. 1-10). Therefore, any “100” series number which corresponds to the number shown and described in connection with the first embodiment need not be further discussed as the structure and operation is the same or very similar to the embodiment shown in FIGS. 1-10. FIGS. 11-17 and 19 best illustrate an alternative adjustment mechanism 180 used to adjust the angle of the removable backrest portion 130 relative to the base fender bracket 112. In particular, each rearwardly extending plate or vertical plate 136, 138 includes a series of notches 184 (only one set shown) formed on a lower rear edge thereof. These notches selectively mate with cam elements 188. Respective cam elements 188 (only one shown) are rigidly affixed to each mounting plate or upstanding support plate 122, 124. This rigid fixation may, for example, be formed by welding each cam element 188 to the respective upstanding support plate 122 or 124. Once the removable backrest portion 130 is fixed in position via the connections respectively made by the cam and notch attachments at the rear and the main clevis pin 150 at the front, the backrest portion 130 is rigidly fixed to the base fender bracket 112. To attain the desired position, the main clevis pin 150 is removed and the desired angle between the backrest portion 130 and the base fender bracket 112 is set by placing the desired notches 184 into mating engagement with the cam elements 188. The holes 122a, 124a are aligned respectively with the holes 136b, 138b and the clevis pin 150 is inserted through each of the aligned holes 122a, 124a, 136b, 138b. FIGS. 13-17 illustrate various adjusted, fixed positions between the backrest portion 130 and the base fender bracket 112. In this embodiment, the clevis pin 150 is fixed in position using a lock 190 inserted through a hole 192 in the clevis pin 150 that is exposed from a sleeve or collar 194 rigidly affixed to the rearward extending vertical plate 136, such as by welding. Once the lock 190 is inserted through the hole 192, the clevis pin 150 may not move in the one direction due to the interference between the lock 190 and the sleeve 194, and cannot move in the opposite direction due to the head 150a of the pin 150 bearing against the upstanding backrest mounting plate 122. FIG. 18 further illustrates a wireless vibrator device 196 that may be mounted within the cushion 132 and which may provide comfort to the user. For example, the vibrator device 196 may be a Shiatsu massage unit. Two screws 198, 200 may be used to secure a panel that provides access to the vibrator device 196, or massage unit, for replacement of batteries or other maintenance. As another embodiment, not shown, a luggage rack may be used in conjunction with the backrest and may use the same clevis pin 150 to lock it in place with the remainder of the removable backrest. This allows the luggage rack to be a quick release item separate from the backrest and the luggage rack may be used with or without the backrest via the same clevis pin 150.

While the present invention has been illustrated by a description of various preferred embodiments and while these embodiments have been described in some detail, it is not the intention of the Applicants to restrict or in any way limit the scope of the appended claims to such detail. Additional advantages and modifications will readily appear to those skilled in the art. The various features of the invention may be used alone or in any combination depending on the needs and preferences of the user. This has been a description of the present invention, along with the preferred methods of practicing the present invention as currently known. However, the invention itself should only be defined by the appended claims.

What is claimed is:

1. A motorcycle backrest, comprising:
a base fender bracket adapted to be rigidly secured to a motorcycle at a position residing over the rear fender, the base fender bracket including first and second upstanding support plates, each including a hole;
a removable backrest portion including a cushion, the removable backrest portion further including first and second rearward extending plates each including a hole; and
a pin configured to extend through the holes in the upstanding plates and through the holes in the rearward extending plates when aligned to thereby removably couple the removable backrest portion to the base fender bracket.

2. The motorcycle backrest of claim 1, further comprising an adjustable connection between the removable backrest portion and the base fender bracket allowing an angle between the cushion and the base fender bracket to be adjusted.

3. The motorcycle backrest of claim 2, wherein the upstanding support plates each include an additional hole, and the rearward extending plates each include a plurality of position adjustment holes, and further comprising another pin configured to extend through the additional holes in the upstanding support plates and through selected ones of the position adjustment holes in the rearward extending plates to thereby set an angular position of the cushion.

4. The motorcycle backrest of claim 2, wherein the adjustable connection further comprises a cam element mating with one or more notches.

5. The motorcycle backrest of claim 1, further comprising a vibrating device and/or massage unit operatively coupled with the cushion.

6. The motorcycle backrest of claim 1, further comprising:
a lock capable of being operatively coupled to the pin for preventing removal of the pin and disconnection of the removable backrest portion from the base fender bracket.

7. The motorcycle backrest of claim 1, further comprising a luggage rack coupled to the removable backrest portion.
